(19) United States
(12) Patent Application Publication
(10) Pub. No.: US 2005/0251545 A1
(43) Pub. Date: Nov. 10, 2005

(54) Learning heavy fourier coefficients

(75) Inventors: Shafi Goldwasser, Rehovot (IL); Adi Akavia, Ramat HaSharon (IL); Shmuel Avraham Safra, Tel-Aviv (IL)

Correspondence Address: DANIEL J SWIRSKY, PO BOX 2345, BEIT SHEMESH, 99544, IL

(73) Assignees: YEDA Research & Dev. Co. Ltd; Ramot at Tel Aviv University Ltd.

(21) Appl. No.: 11/119,888

(22) Filed: May 3, 2005

Related U.S. Application Data
(60) Provisional application No. 60/567,445, filed on May 4, 2004.

(51) Int. Cl. G06F 15/00

(52) U.S. Cl. 708/404

(57) ABSTRACT

A method includes searching in the Z_{N} domain, for N greater than 2, for heavy Fourier coefficients of a function. The method may be implemented for any type of signal compression, such as image, video or audio compression. It may also be used to decode corrupted codewords.

### FIELD OF THE INVENTION

The present invention relates to Fourier transform methods generally.

### BACKGROUND OF THE INVENTION

The well-known Fourier representation, combined with the Fast Fourier transform (FFT), enables fast computation of basic operations which are frequently used in many applications, such as the computation of convolution or correlation of two time series. This has applications in a wide variety of fields such as image, video or audio processing. For example, FFTs are used in digital filtering, image enhancing and modification, pitch modification and signal compression.

The Fourier transform is defined as follows: given a function ƒ(t) over Z_{N} (i.e. a time series), one may consider the Fourier representation of ƒ(t) in which ƒ(t) is represented by its values \hat{ƒ}(ω) for each frequency ω, as follows:

$$\begin{matrix}f ( t ) = {\sum }_{ω = 1}^{N} \hat{f} ( ω ) {ⅇ}^{2 π ω t / N} \\ where \hat{f} ( ω ) = \frac{1}{N} {\sum }_{t = 1}^{N} f ( t ) {ⅇ}^{- 2 π ω t / N}\end{matrix}$$

The FFT is a fast algorithm for computing the Fourier representation, when given access to the signal or function ƒ(t). It is described in many places, for example, in Cooley J. W. and Tukey J. W. “An Algorithm For The Machine Calculation Of Complex Fourier Series”, Mathematics of Computation, 19(90):297-301, 1965. Unfortunately, the FFT takes a significantly long time to compute, on the order of θ(N log N), where N is the number of samples in ƒ(t).

E. Kushilevitz and Y. Mansour, in their article, “Learning Decision Trees Using The Fourier Spectrum” SICOMP, 22(6):1331-1348, 1993, describe an algorithm which learns the “heavy” Fourier coefficients of some functions, where “heavy” is defined as the coefficients with the largest weights, namely, coefficients with the largest squared magnitude, where “largest” describes any weight larger than a threshold τ. In other words, the heavy coefficients are the Fourier coefficients of the most important frequencies in the function ƒ(t). The input function ƒ for the Kushilevitz and Mansour algorithm is a Boolean function over the discrete cube {0, 1}^{k}→{±1}. Their algorithm cannot easily be extended to domains such as {0, . . . ,N−1}^{k} whose inputs have (in each dimension) a significantly larger number of possible values than {0,1}, since their basic checking step, which is at the heart of their algorithm, becomes infeasible with so many possible values.

However, Mansour did extend the algorithm, in “Randomized Interpolation And Approximation Of Sparse Polynomials”, SIAM Journal on Computing, 24(2):357-368, 1995, to one that learns the heavy coefficients of a polynomial P, when given black-box query access to P. Black box query access allows an algorithm to receive the data point for P(x) when x is known, but it does not provide the function P(x). This latter algorithm may be interpreted as an algorithm that finds the heavy Fourier coefficients of a complex function ƒ over the domain Z^{k}_{N}, where the range is all complex values, and the domain is k-tuples of integer values up to the value N (i.e. modulo N), where N is restricted to be a power of 2.

The article by Anna C. Gilbert, Sudipto Guha, Piotr Indyk, S. Muthukrishnan, and Martin Strauss, “Near-optimal Sparse Fourier Representations via Sampling”, STOC 2002, pages 152-161, also discusses a related problem but provides a different solution.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a search procedure for an exemplary function ƒ as it passes through the method of the present invention;

FIG. 2 is a flow chart illustration of the method of the present invention;

FIGS. 3A, 3B and 3C are graphical illustrations of functions, useful in the method of the present invention, where FIG. 3A illustrates an exemplary time domain function ƒ(t), FIG. 3B illustrates a time domain filter I(t) and FIG. 3C illustrates the Fourier transform Î(ω) of time domain filter I(t); and

FIG. 4 is a graphical illustration of an exemplary coding and decoding process.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention may be a search method to find the “heavy” Fourier coefficients at least for arbitrary functions defined over Z_{N} (i.e. the domain of all integers modulo N). The method may be computationally less expensive than the prior art, Fast Fourier Transform (FFT). Hereinbelow, the term “function” may be used to denote a function or a discrete signal.

Given an input threshold τ and query access to a function ƒ, the method of the present invention may generate a relatively short list containing the Fourier coefficients of function ƒ having a weight of at least τ. For functions over Z_{N}, the running time of the algorithm may be polynomial in logN, ∥ƒ∥_{∞}/τ. ∥ƒ∥₂²/τ, and ln(1/δ) where 1−δ represents the confidence level of the algorithm, ∥ƒ∥₂²=(1/N)Σₓ|ƒ(x)|² and ∥ƒ∥_{∞}=maxₓ|ƒ(x)|. Conversely, the running time of the standard FFT, which computes all of the Fourier coefficients of a function, may be NlogN log(∥ƒ∥_{∞}). Thus, in any application for which it may suffice to identify heavy Fourier coefficients, the present invention may yield a significant reduction in complexity.

For example, the present invention may be useful in list decoding of concentrated codes and for approximately learning functions or signals whose weight may be concentrated on a few heavy Fourier coefficients.

The present invention may attempt to find the characters χ_{α} a which are “heavy”, where the α-th character χ_{α} over the additive group Z_{N} may be defined as:

$${χ}_{α} ( x ) {=}^{def} {ω}_{N}^{α x}$$

where

$${ω}_{N} = {ⅇ}^{ⅈ \frac{2 π}{N}}$$

is the primitive root of unity of order N.

The function ƒ may be represented by a “Fourier representation”, using the characters χ_{α}, as follows:

$$\begin{matrix}f = {\sum }_{α ∈ D} \hat{f} ( α ) {χ}_{α} \\ where \text{:} \\ \hat{f} ( α ) {=}^{def} 〈 f , {χ}_{α} 〉 {=}^{def} \frac{1}{N} {\sum }_{i = 1}^{N} f ( i ) \overline{{χ}_{α} ( i )} \\ where \overline{{χ}_{α} ( i )} is the complex congruent\end{matrix}$$

of χ_{α}(i).

The coefficient \hat{ƒ}(α) is called the α-th Fourier coefficient of ƒ and |\hat{ƒ}(α)|² is its weight (where for any complex number z=a+ib, |z|²=a²+b²).

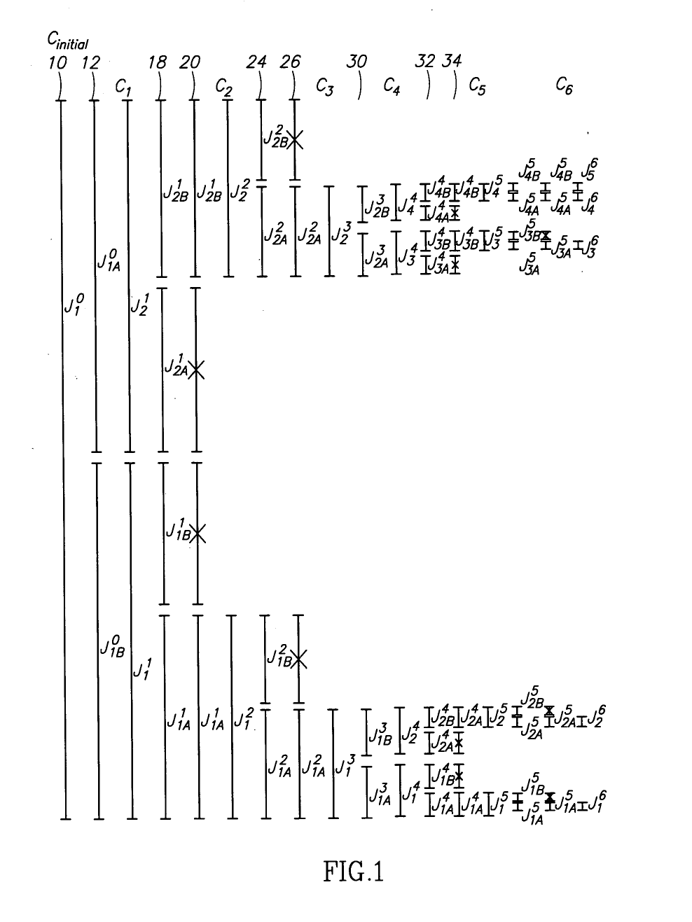

Reference is now made to FIG. 1, which illustrates how the method of the present invention operates for an exemplary function ƒ. The method may search a solution field (of possible solutions) of size N (for N>2) at multiple resolutions, at each resolution determining if the data in the resolution may contain Fourier coefficients which may be heavier than a predefined threshold τ.

The method may begin with an initial collection C₀ of possible outputs in the Fourier domain for function ƒ (for example, integer frequencies 0 to 2,000 Hz). Initial collection C₀ may have an initial interval J₁⁰ of size N, where N may be the number of possible outputs. The interval J₁⁰ may be viewed as a candidate for containing some index a such that χ_{α} may be a heavy character of function ƒ.

The method may consist of a plurality Q of steps where Q may be of order O(logN). At each step t, the resolution of collection Cₜ may be changed, producing the next collection Cₜ₊₁. To do so, each interval Jᵢ^{t} from the collection Cₜ may be divided into B roughly equal intervals, for example, two intervals Jᵢ_{_{A}}^{t} and Jᵢ_{_{B}}^{t} each now roughly of size

$$\frac{N}{{B}^{t + 1}} .$$

For example, as shown in FIG. 1, collection Cᵢₙᵢₜᵢₐₗ, having one interval J₁⁰ in the first step 10, may be divided into two intervals J₁_{_{A}}⁰ and J₁_{_{B}}⁰ in the next step 12.

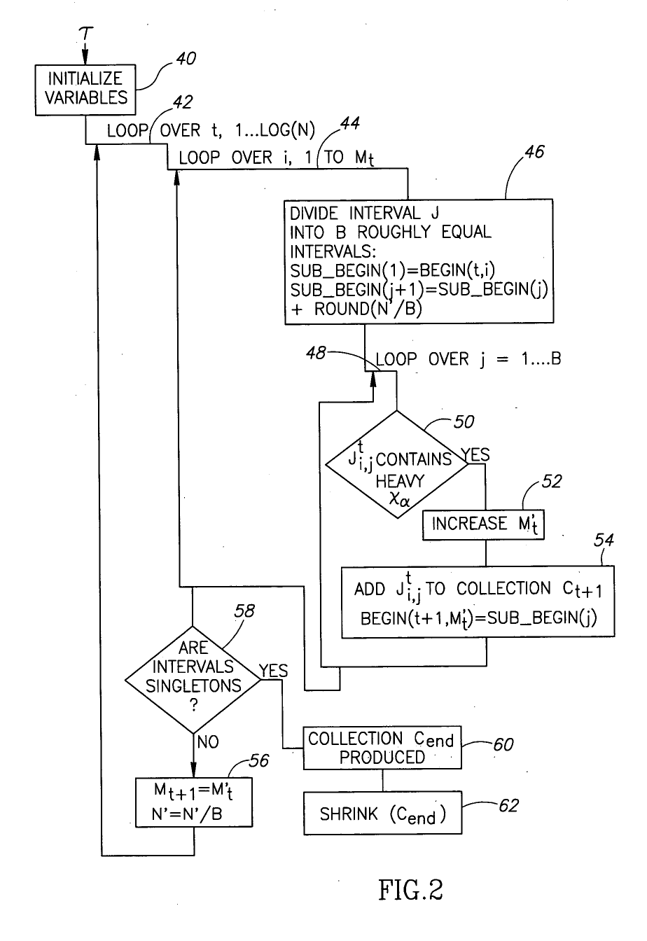

Each sub-interval Jᵢ^{t} may either be inserted into the new collection Cₜ₊₁ or discarded, depending on the outcome of a procedure, described in more detail hereinbelow with reference to FIG. 2, which distinguishes (with a high probability) between intervals Jᵢ^{t} which contain some index a for which χ_{α} is heavy and those intervals Jᵢ^{t} which are “far from” containing any such index α. In the example of FIG. 1, the two intervals J₁_{_{A}}⁰ and J₁_{_{B}}⁰ of step 12 from C₀ are maintained in new collection C₁. In collection C₁, the intervals are renamed J₁¹ and J₂¹ respectively.

Continuing to step 18 in FIG. 1, the two intervals contained by C₁ are shown divided into four intervals J₁_{_{A}}¹, J₁_{_{B}}¹, J₂_{_{A}}¹ and J₂_{_{B}}¹. In step 20, it is determined that only two of the intervals, intervals J₁_{_{A}}¹ and J₂_{_{B}}¹ may be considered candidates for insertion into the next collection C₂. The remaining two intervals J₁_{_{B}}¹ and J₂_{_{A}}¹, are shown in FIG. 1 with X's, indicating that they were determined (with high probability) to be intervals that are far from containing any index α for which χ_{α} is heavy. Thus, intervals J₁_{_{B}}¹ and J₂_{_{A}}¹ are not included in collection C₂; the included intervals J₁_{_{A}}¹ and J₁_{_{B}}¹ are, in turn, renamed according to their new collection C₂ as J₁² and J₂², respectively.

In the next step, step 24, intervals J₁² and J₂² are each shown divided into two intervals, producing four intervals J₁_{_{A}}², J₁_{_{B}}², J₂_{_{A}}² and J₂_{_{B}}². Of these, in step 26, intervals J₁_{_{B}}² and J₂_{_{B}}² are found (with high probability) to be intervals that are far from containing any index α for which χ_{α} is heavy, and are shown with an X through them. Thus, only intervals J₁_{_{A}}² and J₂_{_{A}}² are transferred to collection C₃, where they are renamed J₁³ and J₂³.

The process continues. Collection C₄ is shown containing all four of the intervals J₁⁴,J₂⁴, J₃⁴, J₄⁴ that were produced, in step 30, from C₃, as all of them were determined to be likely to contain a heavy character χ_{α}. Of the eight intervals produced in step 32 from collection C₄, only the following four: J₁_{_{A}}⁴, J₂_{_{B}}⁴, J₃_{_{B}}⁴ and J₄_{_{B}}⁴ are selected in step 34. They are renamed J₁⁵,J₂⁵, J₃⁵ and J₄⁵ in accordance with the present invention in collection C₅. The final collection C₆, is shown containing only five of the eight intervals produced from C₅ and here renamed: J₁⁶, J₂⁶, J₃⁶, J₄⁶ and J₅⁶.

In this example, the five intervals contained in collection C₆ are ‘singleton’ intervals, meaning that they contain only a single value. These five intervals contain all of the heavy characters, and possibly some other characters as well. In a post-processing step, the present invention may further shrink down this list of characters in the collection to coincide (with high probability) with a list of length

$$O ( \frac{{‖ f ‖}_{2}^{2}}{τ} )$$

containing all of the heavy characters of function ƒ, as described hereinbelow.

Although the above describes a binary, multi-resolution method, it will be understood that dividing sub-intervals in half when adding them to the next collection is just one embodiment of the present invention. Intervals may also be divided into three, four, or any small number B of intervals. (B may be polynomial in logN). Moreover, the division need not be equal. For example, for B=2, one interval may contain one-third of the values and the other interval may contain two-thirds of the values. However, the less equal the division amongst the intervals, the less efficient the present invention may be.

Reference is now made to FIG. 2, which illustrates the method of the present invention, in flow chart form.

As in many software applications, the first step (step 40) is to initialize the variables to be used. In particular, the first collection C₀ is set to contain only one interval containing all of the possible values. Moreover, threshold τ is an input to the method, as discussed hereinabove.

In step 42, a loop over t may begin, for t from 1 to logN and in step 44, a loop over i may begin, for i from 1 to Mₜ, where Mₜ may be initialized to 1.

In step 46, the current interval Jᵢ^{t} may be divided into B roughly equal intervals. In the example of FIG. 1, B=2 and thus, current interval Jᵢ^{t} may be divided roughly into two sub-intervals Jᵢ_{_{A}}^{t} and Jᵢ^{t}. If current interval Jᵢ^{t} is of an odd-length, then one of sub-intervals Jᵢ_{_{A}}^{t} and Jᵢ_{_{B}}^{t} may be slightly longer than the other. This is also true if B is not two.

As part of dividing the interval, the beginning of each sub-interval may be stored in a variable sub_begin(j). Thus, if current interval Jᵢ^{t} begins at point begin(t,i) and is of length N′, then:
sub_{—}begin(1)=begin(t,i);
sub_{—}begin(j+1)=sub_{—}begin(j)+round(N′/B)

In step 48, a loop over j may begin, for j from 1 to B. In step 50, the sub-interval J_{i,j}^{t} may be checked, as described hereinbelow. If it contains a heavy character χ_{α}, two actions may occur. First, a next collection count Mₜ′ may be increased (step 52). The number Mₜ′ of intervals that may be added to the collection Cₜ₊₁ is, at most, polynomial in

$$\frac{{‖ f ‖}_{2}^{2}}{τ} .$$

Second, sub-interval J_{i,j}^{t} may be added, in step 54, to the next collection Cₜ₊₁. This may involve storing the beginning location of the added sub-interval in the variable “begin”, as follows:
begin(t+1,Mₜ′)=sub_{—}begin(j)

Once the loop over i has finished, then the number Mₜ of intervals for the next step t+1 and the length N′ of the intervals may be updated (step 56) by:
Mₜ₊₁=Mₜ′
N′=N′/B

The process may continue until loop 42 over t ends, producing a collection C_{end} of singleton intervals. Typically, the check for singleton intervals occurs after the loop over i has finished and before loop 42 increases to the next t. In step 58, a check may be performed asking check whether the intervals of collection Cₜ₊₁ are ‘singletons’; that is, do they contain only a single value? If the answer is no, the process may continue within loop 42 (to step 56). If the intervals are in fact singletons, then the process may exit loop 42 to step 60, where the current collection may be defined as the resultant collection C_{end}.

In step 62, collection C_{end} may be shrunk, in a process described hereinbelow, to find only the heavy characters, producing a collection C_{final}.

The Distinguishing Procedure (Step 50)

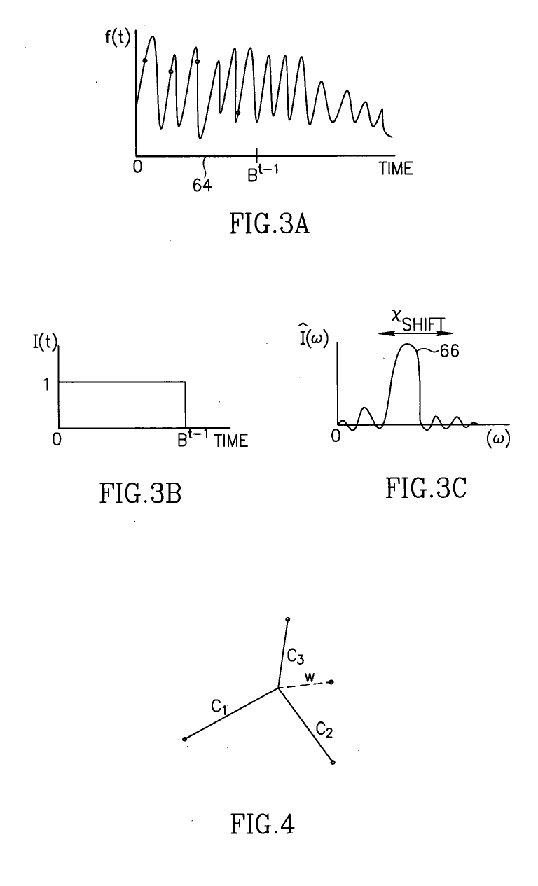

Reference is now made to FIGS. 3A, 3B and 3C which illustrate the distinguishing procedure. FIG. 3A illustrates an exemplary time domain function ƒ(t), FIG. 3B illustrates a time domain filter I(t) and FIG. 3C illustrates the Fourier transform Î(ω) of time domain filter I(t).

The distinguishing procedure may select a random set of data points f(xᵣ) (shown with dots in FIG. 3A) from an initial section 64 (of the points from times 0 . . . B^{t-1}) of the time domain function ƒ(t). Furthermore, the procedure may generate time domain filter I(t) (FIG. 3B) that has a value of 1 in the initial section (0 . . . B^{t-1}) and 0 everywhere else.

The Fourier transform Î(ω) (FIG. 3C) of time domain filter I(t) is a sinc function which has a significant hump 66 in its middle section and some significantly smaller sections to the sides of hump 66. The width of hump 66 is a function of the size of initial section 64. The wider initial section 64 in the time domain is, the thinner hump 66 is. Moreover, hump 66 may be translated within the frequency domain ω using a function χ_{shift}. If hump 66 may represent the interval of a collection Cₜ that begins at the 0^{th} frequency, a multiplier χ_{shift} (shift=−sub_begin(j)) may shift the location of hump 66 to begin at sub_begin(j), the beginning of sub-interval j.

The distinguishing procedure may begin by selecting the indices xᵣ and yₜ of the samples of the time domain function ƒ(t), as follows (steps 1, 2 and 3a):
1. Set the following variables, η, T and m. In one embodiment, these variables may be set as follows:

$$\begin{matrix}η = \frac{τ}{25} \frac{1}{2 {‖ f ‖}_{∞} + 1} , \\ T = \frac{48 {‖ f ‖}_{2}^{2}}{τ} ( \frac{8 {‖ f ‖}_{2}}{\sqrt{τ}} + 1 ) log N , \\ m = 2 {( \frac{{‖ f ‖}_{∞}}{η} )}^{2} ln \frac{4 T}{δ}\end{matrix}$$

where confidence level 1-δ is an input.
2. Randomly choose m samples xᵣ in Z_{N}
3. For each xᵣ,
   a) Randomly choose m samples yₖ in the domain {0, . . . B^{t-1}}

Once the index values may be chosen, then the convolution operation may occur, as follows (step 3b):

$$b ) \qquad Let {q}^{j} ( {x}_{r} ) = {χ}_{shift} ( {x}_{r} ) \cdot \frac{1}{m} {\sum }_{k = 1}^{m} f ( {x}_{r} - {y}_{k} )$$

where shift =−sub_begin(j), j is the current index of loop 48 and χ_{α} is defined hereinabove.

Finally, the convolved signal may be averaged and its value est may be compared to a function of threshold τ. If the convolved signal is significant enough, then it may contain a heavy character (see steps 4 and 5 below).

$$4. \qquad Determine est = \frac{1}{m} {\sum }_{r = 1}^{m} {{q}^{i} ( {x}_{r} )}^{2}$$

5. If est≧τ/8, return Yes; otherwise, return No.

The Shrink Procedure (Step 62)

The list of heavy Fourier coefficients may be shrunk to contain no more than

$$O ( \frac{{‖ f ‖}_{2}^{2}}{τ} )$$

heavy coefficients by estimating a weight

$$\vert {\hat{f} ( α )}^{2} \vert$$

for each candidate in the list, and discarding all candidates with a low weight estimation. The estimation may be done by sampling random inputs x₁, . . . ,xₜ and computing

$$\frac{1}{t} {\sum }_{i = 1}^{t} f ( {x}_{i} ) \cdot {ω}^{- α {x}_{i}} .$$

Applications

The present invention may be utilized in image, video or audio compression which commonly utilizes Fourier transforms. Since compression algorithms expect that most of the signal information will be concentrated in a few coefficients, the present invention may accelerate those compression processes by directly computing the few heavy Fourier coefficients to be used in the compression.

In another application, the present invention may be utilized for list decoding of concentrated codes. Reference is now briefly made to FIG. 4, which illustrates the coding and decoding process. In the example of FIG. 4, there are three orthogonal codewords C₁, C₂ and C₃, each of which may be a binary code (i.e. having values +1 or −1 only). If the codewords Cᵢ are “Fourier concentrated”, each of them may be represented by a small set of Fourier characters χ_{α}. Furthermore, the original codeword is recoverable if there is a recovery algorithm that, given a Fourier character χ_{α}, relatively efficiently finds all codewords for which χ_{α} is heavy.

Frequently, a codeword Cᵢ may be corrupted during transmission, resulting in an input w which does not fall on any of codewords Cᵢ. In the example of FIG. 4, input w falls between codewords C₂ and C₃.

In accordance with a preferred embodiment of the present invention, if codewords Cᵢ are Fourier concentrated and recoverable, then the present invention may find a list L′ that may contain the heavy characters χ_{α} of input w, and the recovery algorithm may then be performed for each heavy character X_{α,k} of input w, to find the codewords Cᵢ whose heavy character list may contain heavy character χ_{α,k}.

Other uses of the present invention, in places where Fourier transforms are performed or where heavy Fourier coefficients are sufficient, are included in the present invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method comprising:
searching in the Z_{N} domain, for N greater than 2, for heavy Fourier coefficients of a function.

2. The method according to claim 1 and wherein said searching is a binary search.

3. The method according to claim 1 and wherein said searching comprises at each iteration, dividing an interval into B intervals.

4. The method according to claim 3 wherein B is no more than polynomial in logN.

5. The method according to claim 3 wherein said searching comprises determining, for each said interval, the probability that said interval does not contain a heavy Fourier coefficient.

6. The method according to claim 5 and also comprising storing said interval for the next iteration if said probability is low.

7. The method according to claim 6 and also comprising shrinking a final collection of intervals using a threshold level.

8. The method according to claim 5 and wherein said determining comprises sampling datapoints within an initial section of a function.

9. The method according to claim 8 and wherein said determining comprises convolving said sampled datapoints with a filter which, in the time domain, has a first value in said initial section and zero everywhere else and shifting said filter, in the frequency domain, to represent a selected interval.

10. A method comprising:
having a recovery algorithm to find codewords for which a Fourier coefficient is heavy;
searching in the Z_{N} domain, for N greater than 2, for at least one heavy Fourier coefficient of a corrupted codeword; and
generating lists of possible codewords which have said at least one heavy Fourier coefficient as one of their heavy Fourier coefficients.

11. A method comprising:
whenever a Fourier transform needs to be performed on a signal in a signal compression method, searching in the Z_{N} domain, for N greater than 2, for heavy Fourier coefficients of said signal.

12. The method according to claim 11 and wherein said signal comprises one of the following types of signals: image, video and audio.

13. Apparatus comprising:
a search unit to search in the Z_{N} domain, for N greater than 2, for heavy Fourier coefficients of a function.

14. Apparatus according to claim 13 and wherein said search unit comprises a binary search unit.

15. Apparatus according to claim 13 and wherein said search unit comprises a divider to divide, at each iteration, an interval into B intervals.

16. Apparatus according to claim 15 wherein B is no more than polynomial in logN.

17. Apparatus according to claim 15 wherein said search unit comprises a distinguisher to determine, for each said interval, the probability that said interval does not contain a heavy Fourier coefficient.

18. Apparatus according to claim 17 and also comprising a storage unit to store said interval for the next iteration if said probability is low.

19. Apparatus according to claim 18 and also comprising a shrinker to shrink a final collection of intervals using a threshold level.

20. Apparatus according to claim 17 and wherein said distinguisher comprises a sampler to sample datapoints within an initial section of a function.

21. Apparatus according to claim 20 and wherein said distinguisher comprises a convolver to convolve said sampled datapoints with a filter which, in the time domain, has a first value in said initial section and zero everywhere else and to shift said filter, in the frequency domain, to represent a selected interval.

22. Apparatus comprising:
a search unit to search in the Z_{N} domain, for N greater than 2, for at least one heavy Fourier coefficient of a corrupted codeword; and
a list generator to generate lists of possible codewords which have said at least one heavy Fourier coefficient as one of their heavy Fourier coefficients.

23. A unit for compressing a signal comprising:
a compression unit to perform signal compression; and
a Fourier transform unit to produce a Fourier transform of at least a form of said signal for said compression unit by searching in the Z_{N} domain, for N greater than 2, for heavy Fourier coefficients of said form of said signal.

24. A unit according to claim 23 and wherein said signal comprises one of the following types of signals: image, video and audio.
